(19) United States
(12) Patent Application Publication
(10) Pub. No.: US 2025/0047326 A1
(43) Pub. Date: Feb. 6, 2025

(54) TRANSMITTING A SIGNAL

(71) Applicant: Telefonaktiebolaget LM Ericsson (publ), Stockholm (SE)

(72) Inventors: Pål FRENGER, Linköping (SE); Erik G. LARSSON, Linköping (SE)

(21) Appl. No.: 18/717,171

(22) PCT Filed: Dec. 11, 2021
(86) PCT No.: PCT/EP2021/085331

§ 371 Date: Jun. 6, 2024

(51) Int. Cl. H04B 7/024; H04B 17/21

(52) U.S. Cl. CPC H04B 7/024; H04B 17/221

(57) ABSTRACT

Methods and apparatus are provided. In an example aspect, a method in a first access point of transmitting a signal is provided. The method includes, for each of a plurality of User Equipments (UEs), determining a phase alignment correction factor (PACF) for the UE based on an access point group associated with the UE, and transmitting a respective first signal to the UE, wherein the first signal is phase adjusted using the PACF determined for the UE.

### TECHNICAL FIELD

Examples of the present disclosure relate to transmitting a signal, for example by an access point, and also to causing an access point to transmit a signal.

### BACKGROUND

The project leading to this application has received funding from the European Union's Horizon 2020 research and innovation programme under grant agreement No 101013425.

Distributed multiple-input multiple-output (D-MIMO, also known as “cell-free massive MIMO”, Radio Stripes, or RadioWeaves) is a key technology candidate for the 3rd Generation Partnership Project (3GPP) 6th generation (6G) physical layer. One basic principle behind D-MIMO is to distribute service antennas geographically and have them operate phase-coherently together. In an example D-MIMO architecture, multiple antenna panels (also referred to as access points or APs) are interconnected and configured in such a way that more than one panel can cooperate in coherent decoding of data from a given UE, and more than one panel can cooperate in coherent transmission of data to a UE. Each antenna panel in turn may comprise multiple antenna elements that are configured to operate phase-coherently together. Example implementations may use time-division duplexing (TDD), relying on reciprocity of the propagation channel, whereby uplink pilots transmitted by the UEs are used to estimate both the uplink and downlink channel responses. This type of TDD operation may be referred to as reciprocity-based operation.

To make deployment of a large number of distributed MIMO access points simple and cost efficient, various solutions have been proposed, such as Radio Stripes and RadioWeaves. A common feature is to use a shared fronthaul together with a high degree of integration and miniaturization. An electronic circuit containing the digital signal processor (DSP), antenna panel, and external interfaces (for power supply and data) is called an antenna processing unit, or APU. In this document these will be referred to as access points (APs). An example of an APU or AP 100 is shown in FIG. 1. The AP 100 includes an antenna panel 102 that comprises four antenna elements 104. The AP 100 also includes four external interfaces 106. The external interfaces in the example AP 100 are located at the edges of the AP 100 such that they may communicate with one or more adjacent APs.

Multiple APs, such as the AP 100, may be connected directly or via one or more other APs to a processing node, also referred to herein as a central processing unit (CPU). In one example network 200, shown in FIG. 2, that uses an arrangement referred to as RadioWeaves, APs 202 may be connected to between one and four adjacent APs 202, and at least one of the APs 202 is connected to a CPU 204. Thus, each of the APs 202 may communicate with the CPU 204. In another example network 300, shown in FIG. 3, which uses an arrangement referred to as Radio Stripes. APs are arranged in multiple series arrangements, referred to as stripes 302, such that each stripe 302 includes multiple APs 304. Within a stripe 302, each AP 304 is connected to the two adjacent APs, with the exception of an AP 304 that is furthest from the CPU 306, which AP 304 is connected only to one adjacent AP 304. Another exception is the AP 304 closest to the CPU 306, which is connected to the CPU 306 and one adjacent AP 304. Thus each AP 304 in the stripes 302 can communicate with the CPU 306.

For reciprocity-based coherent D-MIMO transmission to operate, all transmitting antennas must be appropriately synchronized and calibrated. Specifically, the following three tasks need be accomplished:
A. Each antenna in every panel should be calibrated for uplink-downlink reciprocity, to compensate for phase (and amplitude) mismatches between the receive and transmit branches of the hardware. This can be achieved by using techniques as disclosed in, for example. Rogalin et al (2014). “Scalable synchronization and reciprocity calibration for distributed multiuser MIMO.” IEEE transactions on wireless communications. 13 (4). 1815-1831, or Vieira et al (2017). “Reciprocity calibration for massive MIMO: Proposal, modeling, and validation.” IEEE Transactions on Wireless Communications. 16 (5). 3042-3056. Techniques may for example perform pairwise measurements between the antenna elements located in the same panel, and without interaction among the panels.
B. The antenna panels need agreement on a common frequency reference to drive their mixers. This can be achieved by over-the-air protocols, for example, a master transmitter can broadcast a frequency correction burst. Cable-based (e.g. fiber or ethernet) solutions are also possible.
C. The panels need agreement on a common global phasor in order to be aligned in phase. Since a small time-shift of a narrowband signal is equivalent to a phase-shift, synchronizing to the global phasor can be viewed as performing a fine time synchronization. This is required for joint coherent beamforming in the downlink to work when multiple panels co-operate. One solution is to use a cable or fiber with precise calibration of all electronics to achieve this phase alignment. However, protocols that rely on measurements over the air are also possible. For example, one can use pairwise bi-directional measurements between panels to obtain a common phase reference, as disclosed in for example Rogalin et al referred to above.

It is also possible to involve the UEs in the synchronization and calibration tasks, but this may be undesirable for a number of reasons. For example, there might not be a UE available, or the channel to a UE may weak and/or fading. Relying on the UE also places the burden of network synchronization on the UE, which results in reduced UE battery life. It also introduces additional delay and overhead, resulting in reduced synchronization accuracy and capacity, since the UE measurements need to be communicated to the network before they can be used for synchronization of the network nodes (e.g. APs).

Cooperating antenna panels (also referred to as access points or APs) in distributed MIMO systems must be phase-aligned for coherent beamforming in the downlink to work. State-of-the-art solutions either rely on an external phase reference with very large geographical coverage (GPS/GNSS), or on calibration methods where each AP obtains a phase alignment correction factor (PACF). The PACF can for example be obtained by performing mutual measurements between pairs of APs, or by designating one of the APs as a reference. However, as the network grows, schemes that rely on pairwise measurements between all pairs of APs become infeasible as the communication distances between the APs become too large, and hence the signal-to-noise ratio becomes too low. It also becomes infeasible to designate one of the APs as reference, because other panels that are far enough away will not be able to communicate with it. Existing calibration techniques will break down as the network size is scaled up.

A common solution in the state-of-the-art is to divide the network into disjoint groups and phase calibrate each group of APs independently. An example of a network that includes this arrangement is shown in FIG. 4, which shows an example of a network 400. In the example network 400, a CPU 402 communicates with APs that are arranged into a first stripe 404 of APs 40, a second stripe 408 of APs 410 and a third stripe 412 of APs 414. The APs are divided into a first group 416 and a second group 418. This results in poor performance for User Equipments (UEs) that are located in-between groups. For example, a first UE 420 is located within the geographical area of the first group 416 of APs, whereas a second UE 422 is located between AP groups 416 and 418. Thus, the second UE 422 experiences poor performance, and particularly poor phase coherence of signals received from the first group 416 of APs, or alternatively from the second group 418 of APs.

### SUMMARY

According to embodiments of this disclosure, one or more of the above discussed problems may be mitigated using methods described herein, where in some examples at least one access point AP may maintain at least two PACFs, each PACF being associated with different AP groups, and hence at least one AP may belong to multiple groups. Then, for example, depending on which UE the AP transmits a signal to, the AP selects one of these PACFs and applies it in the downlink beamforming. Each of the PACFs may for example be associated with a different AP group. The PACFs in turn are obtained prior to the downlink transmission, by interaction among different groups of APs.

One aspect of the present disclosure provides a method in a first access point of transmitting a signal. The method comprises, for each of a plurality of User Equipments (UEs), determining a phase alignment correction factor (PACF) for the UE based on an access point group associated with the UE, and transmitting a respective first signal to the UE, wherein the first signal is phase adjusted using the PACF determined for the UE.

Another aspect of the present disclosure provides a method in a network node of causing an access point to transmit a signal. The method comprises determining access point groups for a plurality of access points, wherein at least one first access point of the plurality of access points is in a plurality of the access point groups. The method also comprises, for each of the at least one first access points, causing the first access point to transmit a respective first signal to at least one User Equipment (UE) associated with a first access point group of the plurality of access point groups, wherein the first access point group includes the first access point, and wherein the first signal is phase adjusted using a respective first phase alignment correction factor (PACF) for the first access point based on the first access point group of the plurality of access point groups.

A further aspect of the present disclosure provides apparatus for transmitting a signal. The apparatus comprises a processor and a memory. The memory contains instructions executable by the processor such that the apparatus is operable to, for each of a plurality of User Equipments (UEs), determine a phase alignment correction factor (PACF) for the UE based on an access point group associated with the UE, and transmit a respective first signal to the UE, wherein the first signal is phase adjusted using the PACF determined for the UE.

A still further aspect of the present disclosure provides apparatus for causing an access point to transmit a signal. The apparatus comprises a processor and a memory. The memory contains instructions executable by the processor such that the apparatus is operable to determine access point groups for a plurality of access points, wherein at least one first access point of the plurality of access points is in a plurality of the access point groups, and for each of the at least one first access points, cause the first access point to transmit a respective first signal to at least one User Equipment (UE) associated with a first access point group of the plurality of access point groups, wherein the first access point group includes the first access point, and wherein the first signal is phase adjusted using a respective first phase alignment correction factor (PACF) for the first access point based on the first access point group of the plurality of access point groups

An additional aspect of the present disclosure provides apparatus for transmitting a signal. The apparatus is configured to, for each of a plurality of User Equipments (UEs), determine a phase alignment correction factor (PACF) for the UE based on an access point group associated with the UE, and transmit a respective first signal to the UE, wherein the first signal is phase adjusted using the PACF determined for the UE.

Another aspect of the present disclosure provides apparatus for causing an access point to transmit a signal. The apparatus is configured to determine access point groups for a plurality of access points, wherein at least one first access point of the plurality of access points is in a plurality of the access point groups, and for each of the at least one first access points, cause the first access point to transmit a respective first signal to at least one User Equipment (UE) associated with a first access point group of the plurality of access point groups, wherein the first access point group includes the first access point, and wherein the first signal is phase adjusted using a respective first phase alignment correction factor (PACF) for the first access point based on the first access point group of the plurality of access point groups.

Embodiments of this disclosure may for example provide a phase alignment process that is scalable, and does not break down when the size of the network grows.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of an antenna processing unit (APU) or access point (AP);

FIG. 2 shows an example of a network;

FIG. 3 shows another example of a network;

FIG. 4 shows another example of a network;

FIG. 5 is a flow chart of an example of a method in a first access point of transmitting a signal;

FIG. 6 illustrates an example of a network that includes access points that are associated with multiple AP groups;

FIG. 7 illustrates another example of a network that includes access points that are associated with multiple AP groups;

FIG. 8 illustrates an example of transmission by an access point to a User Equipment;

FIG. 9 shows another example of a network;

FIG. 10 is a flow chart of an example of a method in a network node of causing an access point to transmit a signal;

FIG. 11 is a schematic of an example of an apparatus 1100 for transmitting a signal;

FIG. 12 is a schematic of an example of an apparatus 1100 for transmitting a signal;

FIG. 13 schematically illustrates a telecommunication network connected via an intermediate network to a host computer;

FIG. 14 is a generalized block diagram of a host computer communicating via a base station with a user equipment over a partially wireless connection; and

FIGS. 15 to 18 are flowcharts illustrating methods implemented in a communication system including a host computer, a base station (or access point) and a user equipment.

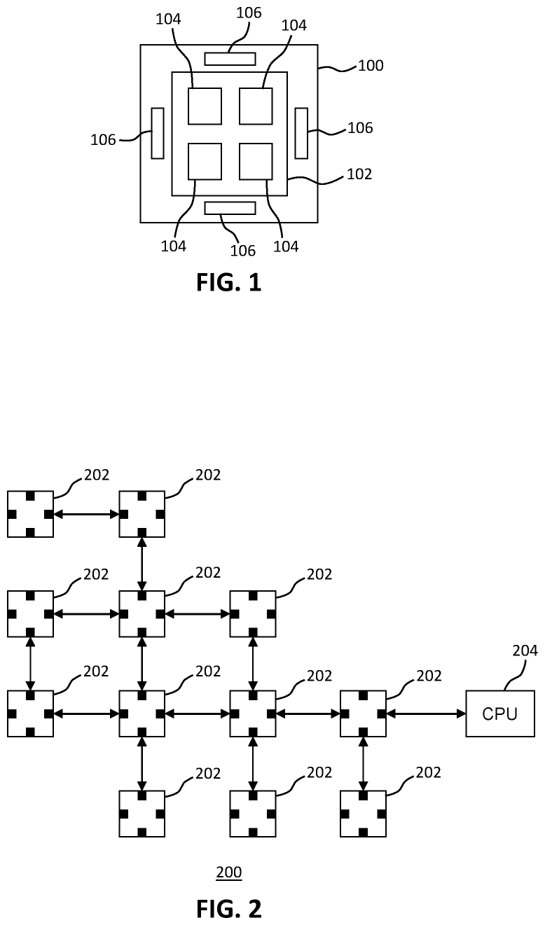

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

As indicated above, example embodiments of this disclosure may provide methods and apparatus whereby an access point may belong to multiple access point groups, and depending on the group associated with a particular UE, a phase alignment correction factor (PACF) that is associated with a particular AP group (or, alternatively, is associated with a particular UE, by virtue of the APs that are serving the UE) is selected to pre-process a signal that is transmitted to the UE. In this way, in some examples, a UE may communicate with any AP group with appropriate PACF and hence the problem of a UE being located between groups may be avoided.

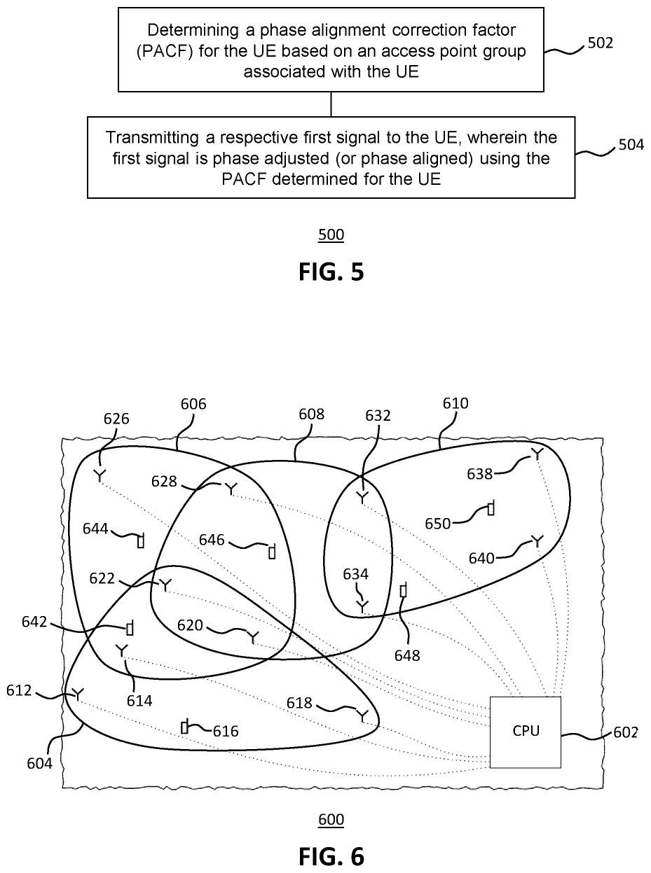

FIG. 5 is a flow chart of an example of a method 500 in a first access point of transmitting a signal. The method comprises steps 502 and 504 that are performed for each of a plurality of User Equipments (UEs). Step 502 of the method 500 comprises determining a phase alignment correction factor (PACF) for the UE based on an access point group associated with the UE (e.g. the access point group that is serving the UE). For example, the PACF for the UE may be determined based on an identifier of the access point group associated with the UE. Step 504 of the method 500 comprises transmitting a respective first signal to the UE, wherein the first signal is phase adjusted (or phase aligned) using the PACF determined for the UE. The PACF for each UE of the plurality of UEs may be determined such that signals transmitted to the UE by access points in the access point group associated with the UE are received at the UE with substantially aligned phases.

Determining the PACF based on the access point group associated with at least one of the UEs in step 502 may in some examples comprise selecting a PACF associated with an access point group associated with each of at least one of the UEs, wherein the access point group includes the first access point. That is, for example, an AP group that is serving each UE may be determined. Then, a PACF for the AP group may be determined (e.g. by retrieving the PACF from storage, where the PACFs for AP groups may be previously calculated). Each UE may be associated with a respective AP group; thus, two particular UEs may be associated with the same AP group or different AP groups. As a result, the first AP is associated with (e.g. a member of) multiple AP groups in some examples.

FIG. 6 illustrates an example of a network 600 that includes access points that are associated with multiple AP groups. The network 600 includes a CPU 602 and a plurality of APs. The APs are arranged into groups, and the example network 600 shown in FIG. 6 includes four groups 604, 606, 608 and 610. The first group 604 includes APs 612, 614, 616, 618 and 620 (i.e. those APs are associated with the first group 604). The second group 606 includes APs 614, 620, 622, 624, 626, 628 and 630. The third group includes APs 620, 628, 630, 632 and 634. Finally, the fourth group 610 includes APs 632, 634, 636, 638 and 640. Thus, for example, each group may include geographically adjacent APs.

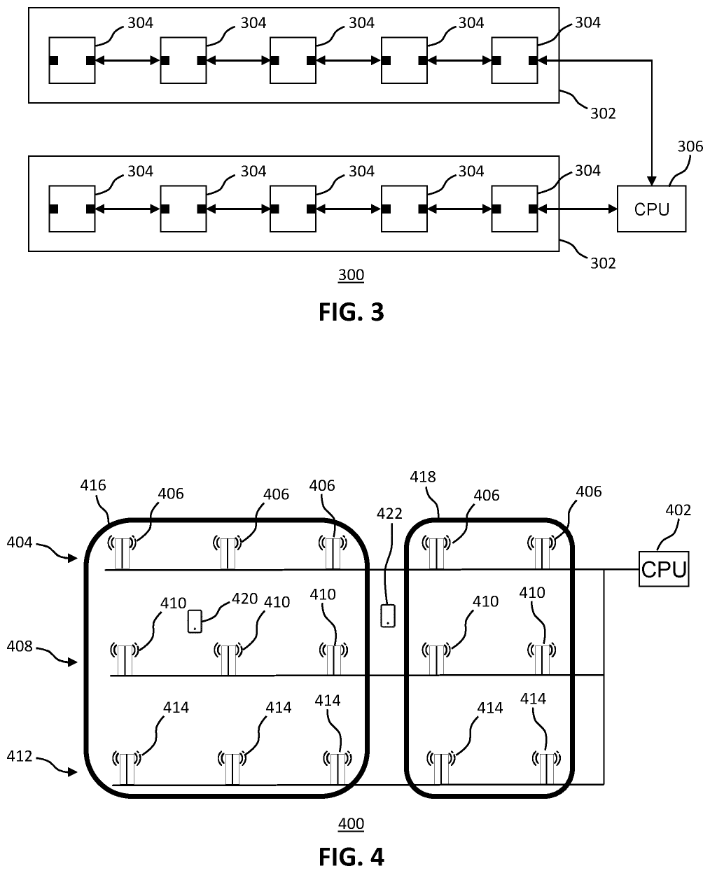

Each of the APs 612-640 may communicate with the CPU, either indirectly or directly, for example using the architecture shown in FIG. 2 or 3. In the example shown in FIG. 6, there are several APs that are associated with two or more groups, including APs 620 and 622 that are associated with three groups. In general, there is no limit as to the number of groups a particular AP may be associated with, and there is no limit as to the number of groups and the number of APs that may be associated with a particular group.

In the example shown in FIG. 6, a first UE 642 is within the coverage area of groups 604 and 606, and thus may be associated with (e.g. served by) either group. A second UE 644 is within the coverage area of group 606 and hence may be associated with that group. If, for example, the first UE 642 is associated with the first group 604, then the AP 614 may for example transmit signals to the first UE 642 using a first PACF that is associated with the first group 604, and transmit signals to the second UE 644 using a second PACF that is associated with the second group 606. It should be noted that the PACF for a particular group may vary between APs in that group, so that for example the PACF used by AP 614 to transmit to the second UE 644 may differ from the PACF used by AP 626 to transmit to the second UE 644, even though both PACFs are associated with the second group 606.

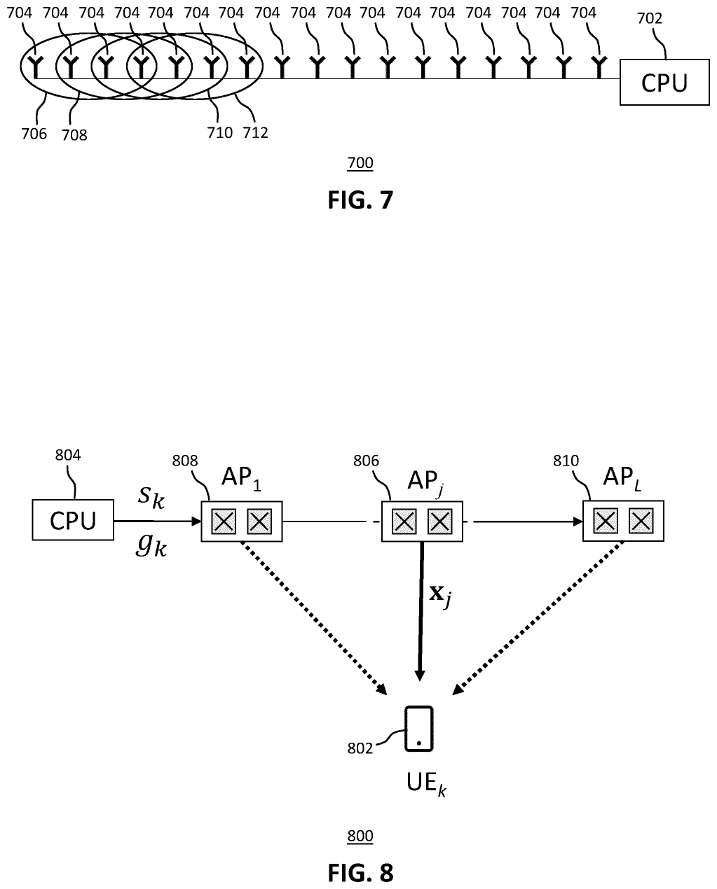

FIG. 7 illustrates another example of a network 700 that includes access points that are associated with multiple AP groups. In this example, a CPU 702 may communicate with APs 704 that are arranged in series (e.g. as a Radio Stripe). The APs are arranged into groups, such that each group includes four APs 704. In the example shown, every group of four adjacent APs is arranged into a group, such that each AP may be associated with up to four groups. The example shown in FIG. 7 illustrates four groups 706, 708, 710 and 712, though there may also be additional groups (not shown). The first group 706 includes the four APs furthest from the CPU 702. The second group 708 includes the three APs in the first group 706 closest to the CPU 702, plus the next closest adjacent AP 704, and so on.

The arrangements of APs into groups shown in FIGS. 6 and 7 are merely illustrative examples, and any suitable manner of arranging APs into groups may be used.

In general, the APs are clustered into a pre-determined number, G, of groups. These groups are typically overlapping such that at least one AP belongs to multiple groups (e.g. the first AP referred to above with reference to the method 500 of FIG. 5), and the groups can be of varying size (i.e. number of associated APs). Let L_{g} be the number of APs in the gth group and denote by {i_{g1}, . . . , i_{gL}_{_{g}}} the indices of the APs that belong to group g.

Within the gth group, a phase alignment protocol may in some examples be executed in order for all APs to obtain L_{g} PACFs that collectively define a common phase reference within that group. In one embodiment, this is accomplished by having the APs in group g perform pairwise measurements on one another, for example as described in Rogalin et al, referred to above. Thus, for example, determining the PACF for each UE based on the access point group associated with the UE comprises determining the access point group associated with the UE from a plurality of access point groups, and wherein the first access point is in each of the access point groups. Then, in some examples, the method 500 may comprise, for each access point group, performing phase alignment with other access points in the access point group to calculate the PACF for the first access point for the access point group.

In other examples, one of the APs in a group g, such as AP j, may be designated as reference and all other APs in that group, {i_{g1}, . . . , i_{gL}_{_{g}}}\j, may obtain their PACF by measuring signals transmitted by AP j. The PACF for a given AP i within a group g of APs can for example be determined by a procedure where AP i transmits a first signal to the reference AP j. The reference AP j then responds with a second signal with conjugated phase. The PACF for AP i is then determined as a function of the received phase (measured at AP i) of the second signal.

In some examples, for an AP i that belongs to group g, let θ_{g,i} be the PACF obtained by AP i when calibrating against the other APs in group g (and thus is the PACF associated with group g). Note that θ_{g,i} is only defined if i∈{i_{g1}, . . . , i_{gL}_{_{g}}}. {θ_{g,i}} (for indices g corresponding to groups that AP i belongs to) may for example be stored in the memory of AP i. In other examples, {θ_{g,i}} may be stored in the CPU. These PACFs may then be distributed to the APs in each group, for example along with a symbol to be transmitted to a UE by each AP in a group.

Once the PACF has been determined for each AP group associated with the first access point, the first access point may forward the PACFs to a central processor (e.g. the CPU referred to herein).

In some examples, determining the PACF based on the access point group associated with each UE comprises receiving an indication of the first PACF or an indication of the access point group associated with the first UE from another access point or a central processor.

The method 500 may in some examples comprise receiving a symbol to be transmitted to one of the UEs from another access point or a central processor, and wherein transmitting the respective first signal to the one of the UEs comprises transmitting the symbol to the UE phase adjusted using the PACF determined for the UE. Additionally or alternatively, for example, transmitting the respective first signal each UE, wherein the first signal is phase adjusted using the PACF determined for the UE, comprises phase rotating the first signal by the PACF.

A particular example of transmission of a signal to a UE will now be described. The first access point referred to above, which may also be referred to as AP i, may be involved in the downlink service of a particular UE. That is, for example, the AP i may transmit downlink signals to the UE as part of an AP group serving the UE. The following steps may be performed:
1. The central processor (e.g. CPU) determines for this UE which APs that will be serving it, with the constraints that there should exist a group g such that these APs belong to group g. Let {j₁, . . . , jⱼ} be the indices of the/APs that are selected to serve the UE. Note that {j₁, . . . , jⱼ}⊂{i_{g1}, . . . , i_{gL}_{_{g}}} (and in particular, J≤L_{g}).
2. The CPU informs APs {j₁, . . . , jⱼ} that they will serve this particular UE, and that they should select their corresponding PACFs associated with group g.
3. Each AP j∈{j₁, . . . , jⱼ} obtains the PACF θ_{g,j} associated with operation in group g. In some examples, θ_{g,j} may be fetched from the memory of AP j. In other examples, θ_{g,j} may be obtained (e.g. received from) from the central processor.
4. The transmission by AP j to the UE is phase-rotated by θ_{g,j}.

FIG. 8 shows an example of transmission by an AP j to a UE according to this procedure. For a User Equipment UEₖ 802, the CPU 804 provides a data symbol sₖ to be transmitted by APⱼ 806. The UEₖ 802 has been assigned a group with index gₖ of cooperating APs (of which APⱼ 806 is a member) and that group of APs (including APs 806, 808 and 810 shown in FIG. 8) has an associated set of phase alignment factors denoted {θ_{g}_{ₖ}_{,j}}. The transmission power and antenna panel pre-coding vector used by APⱼ 806 when transmitting to UEₖ 702 are denoted ρ_{k,j} and W_{k,j}, respectively. The signal xⱼ transmitted from APⱼ 806 consists of signals to multiple UEs k=1, . . . , K and different UEs may be associated with different phase alignment groups with different phase alignment factors. The UEₖ 802 may for example perform coherent signal addition of signals transmitted to it by the APs in its associated AP group.

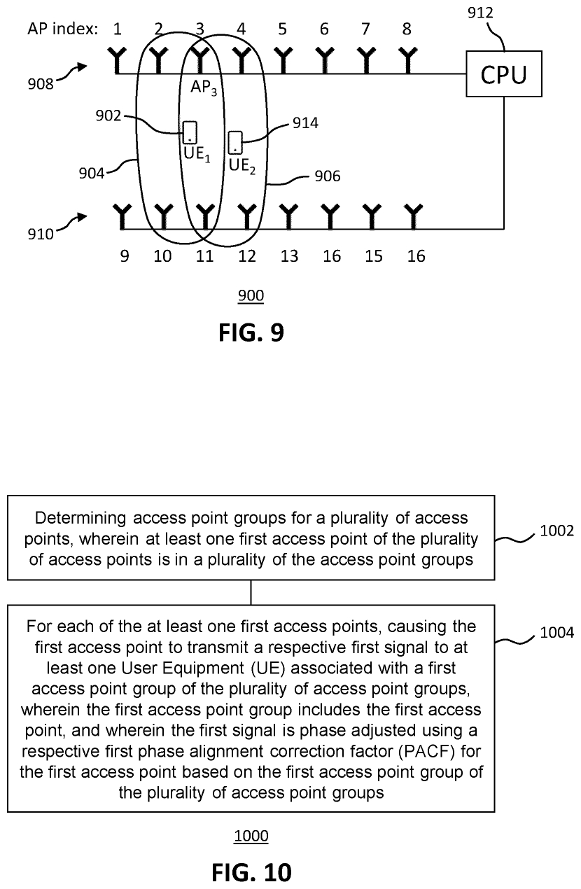

FIG. 9 shows another example of a network, in which a User Equipment UE₁ 902 can be served by both phase alignment group g₁ 904 and phase alignment group g₂ 906. APs in the example network 900 have an index 1, . . . 16, and are arranged into strips, whereby a first stripe 908 includes APs with index 1-8 whereas a second strip 910 includes APs with index 9-16. The APs in group g₁ 904 may be mutually phase-aligned, and the APs in group g₂ 906 may be mutually phase-aligned. However, there may be a phase discrepancy between the phase references between the two groups.

In the example network 900 shown in FIG. 9, serving APs are provided with information (from the CPU 912 in this example) on which phase alignment group each UE 902, 914 is associated with. In this example, AP₃ (i.e. the AP with index 3) serves both UE₁ 902 and UE₂ 914 and since the two UEs are assigned to different groups of cooperating APs with different phase compensating factors, AP; needs to apply different phase compensation factors (PACFs) when transmitting to UE₁ 902 and UE₂ 914 respectively. That is, for example, AP; may receive downlink data symbols {s₁, s₂} for UE₁ 902 and UE₂ 914 respectively from the CPU 912, and may also receive an indication of phase alignment groups {g₁, g₂} for UE, 902 and UE₂ 914 respectively from the CPU 912. The AP; may then transmit the following signal to UE₁ 902 and UE₂ 914:

$${x}_{l} = \sqrt{{ρ}_{1}} {w}_{1} {s}_{1} {e}^{j {θ}_{{g}_{1}}} + \sqrt{{ρ}_{2}} {w}_{2} {s}_{2} {e}^{j {θ}_{{g}_{2}}}$$

In more detail, first, the APs in 9 obtain their set of PACFs. The APs that belong to the first group 904 obtain this by mutual measurements on other APs in the first group 904, that is, the APs with indexes 2, 3, 10 and 11, resulting in a respective PACF associated with the first group for each of the APs with index 2, 3, 10 and 11. These PACFs may be used when transmitting signals together with other APs that belong to the first group 904. Similarly, the APs in the second group 906 with index 3, 4, 11 and 12 each obtain a respective PACF associated with the second group 906 by mutual measurements with other APs in the second group 906. Thus, APs with index 2, 3, 10 and 11 each obtain one respective PACF associated with the first AP group 904 (and which may vary between APs in the first group 904) and APs with index 3, 4, 11 and 12 each obtain one respective PACF associated with the second AP group 906 (and which may vary between APs in the second group 906). APs that belong to multiple groups, i.e. APs with index 3 and 11 in this example, may obtain multiple PACFs for the different groups, and the PACF values may differ for the different groups.

FIG. 10 is a flow chart of an example of a method 1000 in a network node of causing an access point to transmit a signal. The network node may for example be a central processor such as a CPU referred to herein, or alternatively may be any other node in a network including for example an access point. In some examples, the network node may perform the method 1000 while one or more APs in the network perform the method 500 referred to above.

The method 1000 comprises, in step 1002, determining access point groups for a plurality of access points, wherein at least one first access point of the plurality of access points is in a plurality of the access point groups. The method 1000 also comprises, in step 1004, for each of the at least one first access points, causing the first access point to transmit a respective first signal to at least one User Equipment (UE) associated with a first access point group of the plurality of access point groups. The first access point group includes the first access point, and the first signal is phase adjusted using a respective first phase alignment correction factor (PACF) for the first access point based on the first access point group of the plurality of access point groups. The access point group associated with the UE may be the access point group that is serving the UE.

In some examples, at least one second access point of the plurality of access points is in a plurality of the access point groups. Thus, for example, the method comprises, for each of the at least one second access points, causing the second access point to transmit a respective second signal to at least one User Equipment (UE) associated with a first access point group of the plurality of access point groups, wherein the first access point group includes the first access point, and wherein the first signal is phase adjusted using a respective first phase alignment correction factor (PACF) for the first access point based on the first access point group of the plurality of access point groups. Thus, for example, problems associated with UEs being between access point groups may be avoided by allowing APs to belong to multiple groups.

In some examples, the method 1000 comprising receiving, from each of the plurality of access points, an indication of one or more PACFs for each access point group that includes the access point. Thus for example the network node (e.g. central processor or CPU) may store the PACF values and use them when sending symbols to the APs for transmission, e.g. each symbol to be transmitted by an AP may be sent to the AP along with the appropriate PACF for the symbol (i.e. the PACF associated with the access point group associated with/serving the UE to which the symbol is to be transmitted).

The method 1000 may also comprise, in some examples, for each of the at least one first access points, causing the first access point to transmit the respective first signal to at least one UE associated with a first access point group causes the first access point to transmit the first signal phase rotated by the respective PACF for the first access point for the first group.

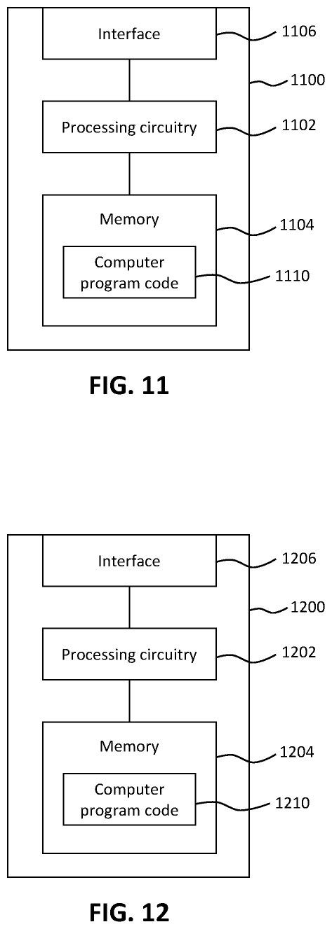

FIG. 11 is a schematic of an example of an apparatus 1100 for transmitting a signal. The apparatus 1100 comprises processing circuitry 1102 (e.g., one or more processors) and a memory 1104 in communication with the processing circuitry 1102. The memory 1104 contains instructions, such as computer program code 1110, executable by the processing circuitry 1102. The apparatus 1100 also comprises an interface 1106 in communication with the processing circuitry 1102. Although the interface 1106, processing circuitry 1102 and memory 1104 are shown connected in series, these may alternatively be interconnected in any other way, for example via a bus.

In one embodiment, the memory 1104 contains instructions executable by the processing circuitry 1102 such that the apparatus 1100 is operable/configured to, for each of a plurality of User Equipments (UEs), determine a phase alignment correction factor (PACF) for the UE based on an access point group associated with the UE, and transmit a respective first signal to the UE, wherein the first signal is phase adjusted using the PACF determined for the UE. In some examples, the apparatus 1100 is operable/configured to carry out the method 500 described above with reference to FIG. 5.

FIG. 12 is a schematic of an example of an apparatus 1100 for transmitting a signal. The apparatus 1200 for causing an access point to transmit a signal. The apparatus 1200 comprises processing circuitry 1202 (e.g., one or more processors) and a memory 1204 in communication with the processing circuitry 1202. The memory 1204 contains instructions, such as computer program code 1210, executable by the processing circuitry 1202. The apparatus 1200 also comprises an interface 1206 in communication with the processing circuitry 1202. Although the interface 1206, processing circuitry 1202 and memory 1204 are shown connected in series, these may alternatively be interconnected in any other way, for example via a bus.

In one embodiment, the memory 1204 contains instructions executable by the processing circuitry 1202 such that the apparatus 1200 is operable/configured to determine access point groups for a plurality of access points, wherein at least one first access point of the plurality of access points is in a plurality of the access point groups, and for each of the at least one first access points, cause the first access point to transmit a respective first signal to at least one User Equipment (UE) associated with a first access point group of the plurality of access point groups, wherein the first access point group includes the first access point, and wherein the first signal is phase adjusted using a respective first phase alignment correction factor (PACF) for the first access point based on the first access point group of the plurality of access point groups. In some examples, the apparatus 1200 is operable/configured to carry out the method 1000 described above with reference to FIG. 10.

Examples of the present disclosure also include apparatus for transmitting a signal. The apparatus comprises a determining module configured to, for each of a plurality of User Equipments (UEs), determine a phase alignment correction factor (PACF) for the UE based on an access point group associated with the UE. The apparatus also comprises a transmit module configured to, for each of the plurality of UEs, transmit a respective first signal to the UE, wherein the first signal is phase adjusted using the PACF determined for the UE.

Examples of the present disclosure also include apparatus for causing an access point to transmit a signal. The apparatus comprises a determining module configured to determine access point groups for a plurality of access points, wherein at least one first access point of the plurality of access points is in a plurality of the access point groups. The apparatus also comprises a causing module configured to, for each of the at least one first access points, cause the first access point to transmit a respective first signal to at least one User Equipment (UE) associated with a first access point group of the plurality of access point groups, wherein the first access point group includes the first access point, and wherein the first signal is phase adjusted using a respective first phase alignment correction factor (PACF) for the first access point based on the first access point group of the plurality of access point groups.

Examples of this disclosure may also provide a communication system including a host computer comprising processing circuitry configured to provide user data, and a communication interface configured to forward the user data to a network for transmission to a user equipment (UE), wherein the network comprises a base station (or access point) having a radio interface and processing circuitry, the base station's processing circuitry configured to perform any of the example methods as disclosed herein performed by an access point. The system may further include the base station. Additionally or alternatively, the system may further include the UE, wherein the UE is configured to communicate with the base station. The processing circuitry of the host computer may be configured to execute a host application, thereby providing the user data, and the UE may comprise processing circuitry configured to execute a client application associated with the host application.

Examples of this disclosure may also provide a method implemented in a communication system including a host computer, a base station (or access point) and a user equipment (UE). The method comprises, at the host computer, providing user data and, at the host computer, initiating a transmission carrying the user data to the UE via a network comprising the base station, wherein the base station may perform any of the example methods as disclosed herein performed by an access point. THE method may also comprise, at the base station, transmitting the user data. The user data may be provided at the host computer by executing a host application, the method may further comprise, at the UE, executing a client application associated with the host application.

Examples of this disclosure may also provide a communication system including a host computer comprising processing circuitry configured to provide user data, and a communication interface configured to forward user data to a network for transmission to a user equipment (UE). The UE comprises a radio interface and processing circuitry, the UE's processing circuitry configured to perform any of the example methods as disclosed herein performed by a UE. The system may further include the UE. The network may further include a base station (or access point) configured to communicate with the UE. The processing circuitry of the host computer may be configured to execute a host application, thereby providing the user data, and the UE's processing circuitry may be configured to execute a client application associated with the host application.

Examples of this disclosure may also provide a method implemented in a communication system including a host computer, a base station (or access point) and a user equipment (UE), the method comprising, at the host computer, providing user data and, at the host computer, initiating a transmission carrying the user data to the UE via a network comprising the base station, wherein the UE may perform any of the example methods as disclosed herein performed by a UE. The method may further comprise, at the UE, receiving the user data from the base station.

Examples of this disclosure may also provide a communication system including a host computer comprising a communication interface configured to receive user data originating from a transmission from a user equipment (UE) to a base station (or access point), wherein the UE comprises a radio interface and processing circuitry, the UE's processing circuitry configured to perform any of the example methods as disclosed herein performed by a UE. The system may further include the UE. The system may further include the base station, wherein the base station comprises a radio interface configured to communicate with the UE and a communication interface configured to forward to the host computer the user data carried by a transmission from the UE to the base station. The processing circuitry of the host computer may be configured to execute a host application, and the UE's processing circuitry may be configured to execute a client application associated with the host application, thereby providing the user data. The processing circuitry of the host computer may be configured to execute a host application, thereby providing request data, and the UE's processing circuitry may be configured to execute a client application associated with the host application, thereby providing the user data in response to the request data.

Examples of this disclosure may also provide a method implemented in a communication system including a host computer, a base station (or access point) and a user equipment (UE). The method comprises, at the host computer, receiving user data transmitted to the base station from the UE, wherein the UE may perform any of the example methods as disclosed herein performed by a UE. The method may further comprise, at the UE, providing the user data to the base station. The method may further comprise, at the UE, executing a client application, thereby providing the user data to be transmitted and, at the host computer, executing a host application associated with the client application. The method may further comprise, at the UE, executing a client application and, at the UE, receiving input data to the client application, the input data being provided at the host computer by executing a host application associated with the client application, wherein the user data to be transmitted is provided by the client application in response to the input data.

Examples of this disclosure may also provide a communication system including a host computer comprising a communication interface configured to receive user data originating from a transmission from a user equipment (UE) to a base station (or access point), wherein the base station comprises a radio interface and processing circuitry, the base station's processing circuitry configured to perform any of the example methods as disclosed herein performed by a UE. The system may further include the base station. The system may further include the UE, wherein the UE is configured to communicate with the base station. The processing circuitry of the host computer may be configured to execute a host application, and the UE may be configured to execute a client application associated with the host application, thereby providing the user data to be received by the host computer.

Examples of this disclosure may also provide a method implemented in a communication system including a host computer, a base station (or access point) and a user equipment (UE). The method comprises, at the host computer, receiving, from the base station, user data originating from a transmission which the base station has received from the UE, wherein the UE may perform any of the example methods as disclosed herein performed by a UE. The method may further comprise, at the base station, receiving the user data from the UE. The method may further comprise, at the base station, initiating a transmission of the received user data to the host computer.

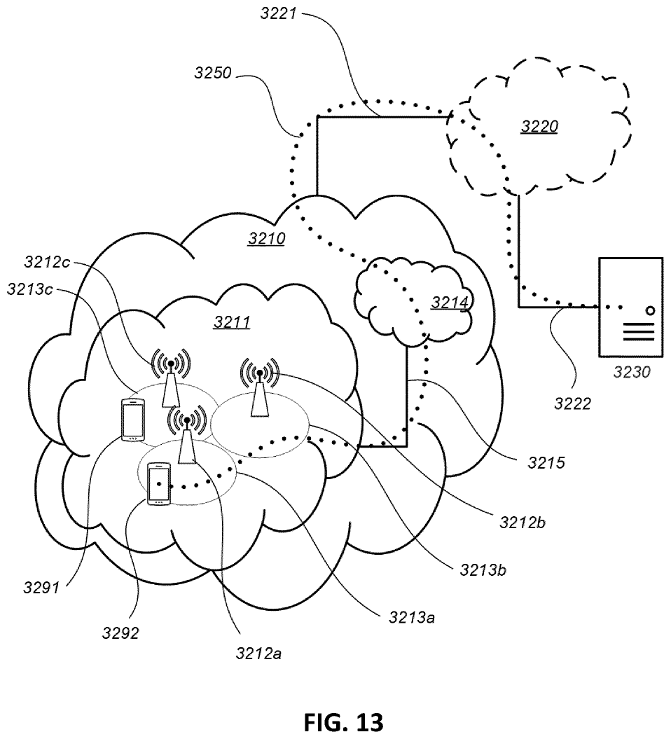

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a. 3212b. 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network: the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

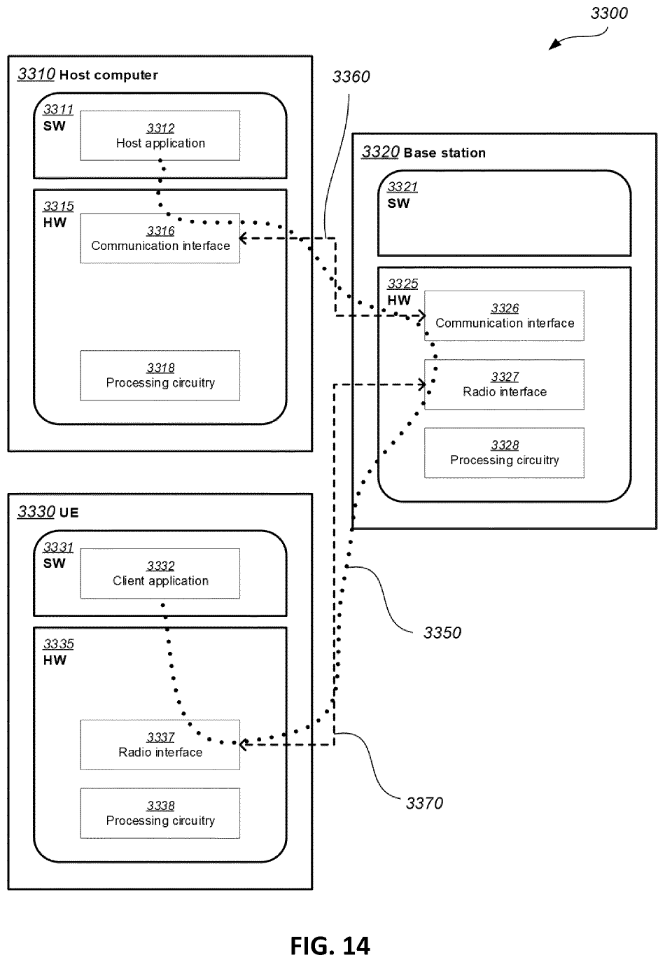

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

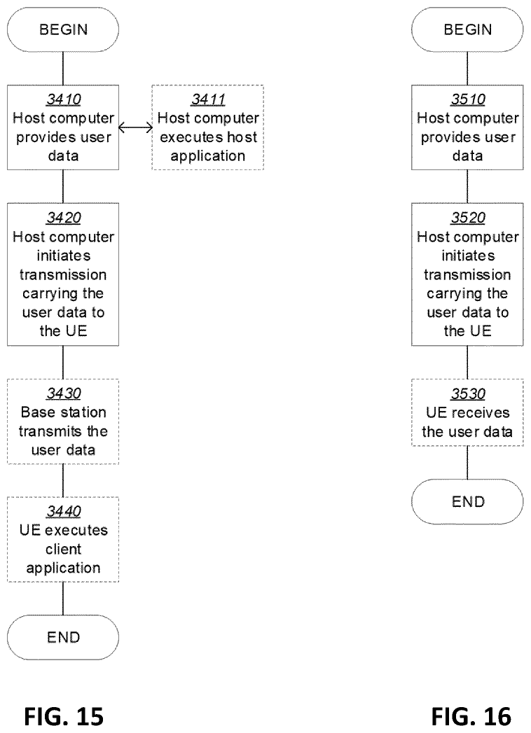

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

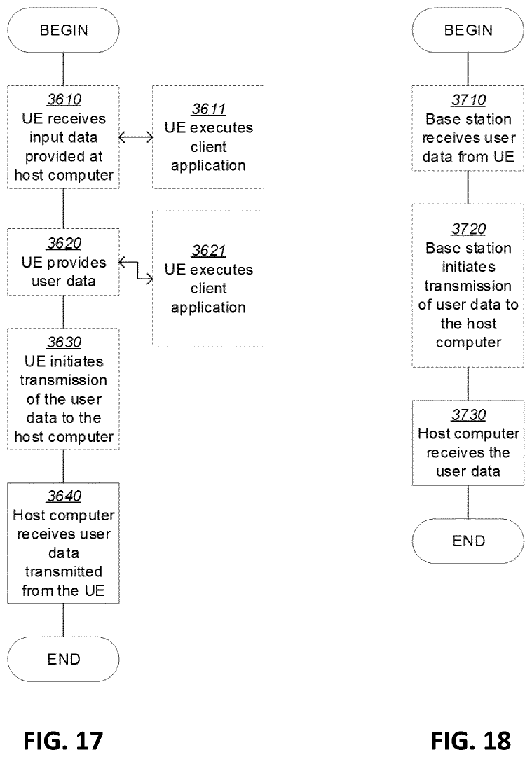

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a first access point of transmitting a signal, the method comprising, for each of a plurality of User Equipments:
obtaining multiple phase alignment correction factors for different access point groups, the first access point belonging to multiple access point groups, the PACF values differing for the different access point groups;
determining an access point group associated with the UE from the plurality of access point groups, the first access point being in each of the access point groups;
determining the PACF for the UE based on the access point group associated with the UE; and
transmitting a respective first signal to the UE, the first signal being phase adjusted using the PACF determined for the UE.

2. The method of claim 1, wherein the PACF for each UE is determined such that signals transmitted to the UE by access points in the access point group associated with the UE are received at the UE with aligned phases.

3. The method of claim 1, wherein determining the PACF based on the access point group associated with at least one of the UEs comprises selecting a PACF associated with an access point group associated with each of at least one of the UEs, wherein the access point group includes the first access point.

4. The method of claim 1, wherein the access point group associated with each UE comprises an access point group serving the UE.

5. The method of claim 1, wherein determining the PACF based on the access point group associated with each UE comprises receiving an indication of the first PACF or an indication of the access point group associated with the first UE from another access point or a central processor.

6. The method of claim 1, comprising receiving a symbol to be transmitted to one of the UEs from another access point or a central processor, and wherein transmitting the respective first signal to the one of the UEs comprises transmitting the symbol to the UE phase adjusted using the PACF determined for the UE.

7. (canceled)

8. The method of claim 1, comprising, for each access point group, performing phase alignment with other access points in the access point group to calculate the PACF for the first access point for the access point group.

9. The method of claim 8, comprising forwarding the PACF for each access point group to a central processor.

10. The method of claim 1, wherein transmitting the respective first signal each UE, wherein the first signal is phase adjusted using the PACF determined for the UE, comprises phase rotating the first signal by the PACF.

11. The method of claim 1, wherein determining the PACF for each UE based on the access point group associated with the UE comprises determining the PACF for the UE based on an identifier of the access point group associated with the UE.

12. A method in a network node of causing an access point to transmit a signal, the method comprising:
determining access point groups for a plurality of access points, wherein at least one first access point of the plurality of access points being in a plurality of the access point groups, the first access point obtaining multiple phase alignment correction factors (PACFs) for different access point groups, the PACF values differing for the different access point groups; and
for each of the at least one first access points, causing the first access point to transmit a respective first signal to at least one User Equipment (UE) associated with a first access point group of the plurality of access point groups, wherein the first access point group including the first access point, and wherein the first signal is phase adjusted using a respective PACF for the first access point based on the first access point group of the plurality of access point groups.

13. The method of claim 12, wherein at least one second access point of the plurality of access points is in a plurality of the access point groups and the method 1000 comprises, for each of the at least one second access points, causing the second access point to transmit a respective second signal to at least one User Equipment (UE) associated with a first access point group of the plurality of access point groups, wherein the first access point group includes the first access point, and wherein the first signal is phase adjusted using a respective first phase alignment correction factor (PACF) for the first access point based on the first access point group of the plurality of access point groups.

14. The method of claim 12, comprising receiving, from each of the plurality of access points, an indication of one or more PACFs for each access point group that includes the access point.

15. The method of claim 12, comprising determining one or more of the access point groups for each of the plurality of access points.

16. The method of claim 15, comprising sending, to each of the plurality of access points, the one or more groups that include the access point.

17. The method of claim 12, comprising receiving, from each of the plurality of access points, one or more PACFs for the access point for one or more access point groups that include the access point.

18. The method of claim 12, wherein the first access point group associated with the at least one UE comprises an access point group serving the UE.

19. The method of claim 12, wherein, for each of the at least one first access points, causing the first access point to transmit the respective first signal to at least one UE associated with a first access point group causes the first access point to transmit the first signal phase rotated by the respective PACF for the first access point for the first group.

20. The method of claim 12, wherein, for each of the at least one first access points, causing the first access point to transmit the respective first signal to at least one UE associated with a first access point group comprises sending, to the first access point, one or more respective symbols to be transmitted to the at least one UE.

21. The method of claim 20, comprising sending, to the first access point, the respective PACF to be used when transmitting the one or more respective symbols to the at least one UE.

22.-49. (canceled)
